(19) United States
(12) Patent Application Publication
(10) Pub. No.: US 2014/0082264 A1
(43) Pub. Date: Mar. 20, 2014

(54) NAND FLASH STORAGE CHIP CHECKING METHOD AND DEVICE

(71) Applicant: PAX COMPUTER TECHNOLOGY (SHENZHEN) co., LTD., Shenzhen (CN)

(72) Inventors: Laimin Wan, Shenzhen (CN); Xiankang Wei, Shenzhen (CN); Shaohai Liu, Shenzhen (CN)

(73) Assignee: PAX COMPUTER TECHNOLOGY (SHENZHEN) CO., LTD., Shenzhen (CN)

(21) Appl. No.: 14/005,140

(22) PCT Filed: Dec. 7, 2012
(86) PCT No.: PCT/CN2012/086106

§ 371 Date: Sep. 13, 2013

(30) Foreign Application Priority Data
Jul. 19, 2012 (CN) 201210251133.7
Nov. 19, 2012 (CN) 201210468353.5

(51) Int. Cl. G06F 12/02

(52) U.S. Cl. CPC G06F 12/0246
USPC 711/103

(57) ABSTRACT

A NAND flash storage chip correcting method is provided in the present invention. The method can correct one or two bits errors and find a number of bits errors according to the row and column XOR value and Hash value of each page written into the spare area, comparing the data stored in the data area and the computed Hash value of data area to correct one or two bits of errors, thus ensures the accuracy and integrity of the data stored in the NAND Flash chip and reduces the risk of crash of the file system.

### TECHNICAL FIELD

The present invention relates to communication field, and more particularly, to a NAND flash storage chip checking method and device.

### BACKGROUND

Currently, comparing with the NOR flash storage, NAND flash storage chip as a common storage media in a embedded filed has advantages of faster reading and writing speed and more data storage capability. Therefore, the NAND flash storage chip is favored by the embedded device manufacturer. However, because the NAND flash storage chip is unlike the NOR flash storage which can keep high reliability in data storage, it is difficult for the user to improve the reliability in data storage of NAND flash.

Generally, the NAND flash chip is formed by a number of blocks. Each of the number of blocks is formed by a number of pages. Each of the number of pages is formed by data areas and spare areas. The block is the smallest erasing unit of the NAND flash. The page is the smallest reading/writing unit of NAND flash. The data areas of each page is for storing user data and the spare area of each page is for storing error correcting checksum.

There are three typical situations existing in the NAND flash may result data flipping and thereby results data error, the three typical situation are described as following:

1. Drifting Flip

The drifting flip refers that the voltage values of the cells of the NAND flash are changed gradually and are changed differently from the original ones.

2. Program Effect Causing Flip

The program effect causing flip refers that program operations (erasing/writing operation) on one page causes jumping of one bit of the other unrelated pages.

3. Reading Flip

The reading flip refers that a reading operation on one page results in the data in one bit of the page is changed forever, namely the data in this bit of the NAND flash is changed.

The technology character of the NAND flash makes the data read from the NAND flash is different from the data write into the NAND flash. Therefore, the NAND flash uses the specific Error Checking and Correction (ECC) checkout algorithm to ensure the correctness of the data read from the NAND flash. The ECC checkout algorithm can correct single error and detect double error. However, it is found that two errors often occur on one page after a high pressure test. Once two errors occur on one page, it is results a crash of the file system set on the NAND flash. Therefore, a checkout algorithm is needed to reduce the risk of crash of the file system.

### SUMMARY

An object of the embodiments of the present invention is for providing a NAND flash storage chip checking method to solve the problem that the known correcting method only can be used to check one bit error and detect two bits errors.

The NAND flash storage chip checking method includes:

operating an XOR operation to all data in the same row of the data area of each page of the NAND flash storage chip to get a row XOR value and operating an XOR operation to all data in each column of the data area of each page of the NAND flash storage chip to get a column XOR value, and writing the row XOR value and the column XOR value to an spare area of the NAND flash storage chip;

operating a Hash operation to the data in the data area and store double operation results to the spare area;

fetching the data stored in the data area and computing the Hash value of the data fetched from the data area;

fetching the row and column XOR value and the double stored hash values stored on the spare area and operating the double stored hash values to get a new Hash value;

comparing the Hash value of the data in the data area and the new Hash value to determine whether the Hash value of the data in the data area is the same as the new Hash value, if not, operating XOR operation to the rows and columns of the data in the data area to get row and column XOR values, comparing the row and column XOR values of the data area with the row and column XOR values of the spare area to obtain the number and position of the rows and columns generating errors, and correcting errors according to the obtained number and position of the rows and columns generating errors.

The NAND flash storage chip checking device, comprising:

a writing unit for operating an XOR operation to all data in the same row of the data area of each page of the NAND flash storage chip to get a row XOR value and operating an XOR operation to all data in each column of the data area of each page of the NAND flash storage chip to get a column XOR value, and writing the row XOR value and the column XOR value to an spare area of the NAND flash storage chip;

a first operating unit for operating a Hash operation to the data in the data area and store double operation results to the spare area;

a computing unit for fetching the data stored in the data area and computing the Hash value of the data fetched from the data area;

a second operating unit for fetching the row and column XOR value and the double stored hash values stored on the spare area and operating the double stored hash values to get a new Hash value;

a correcting unit for comparing the Hash value of the data in the data area and the new Hash value to determine whether the Hash value of the data in the data area is the same as the new Hash value, if not, operating XOR operation to the rows and columns of the data in the data area to get row and column XOR values, comparing the row and column XOR values of the data area with the row and column XOR values of the spare area to obtain the number and position of the rows and columns generating errors, and correcting errors according to the obtained number and position of the rows and columns generating errors.

Compared with the known technology, the NAND flash storage chip correcting method provided in the present invention can correct one or two bits errors and find a number of bits errors according to the row and column XOR value and Hash value of each page written into the spare area, comparing the data stored in the data area and the computed Hash value of data area to correct one or two bits of errors, thus ensures the accuracy and integrity of the data stored in the NAND Flash chip and reduces the risk of crash of the file system.

### BRIEF DESCRIPTION OF THE DRAWINGS

In order to clearly describe the technical solutions of the embodiments of the present invention, the accompany drawings used in the embodiments will be simply described below. Obviously, the accompany drawings described below only a part of embodiments of the present invention, the ordinary skill person in the art, without creative efforts, can also obtain other accompany drawings according to the accompany drawings described below.

FIG. 1 is a flow chart of a NAND flash storage chip checking method in accordance with the first embodiment of the present invention.

FIG. 2 is a schematic view of a NAND flash storage chip checking method in accordance with the first embodiment of the present invention.

FIG. 3 is a schematic view of a NAND flash storage chip checking method in accordance with the first embodiment of the present invention.

FIG. 4 is a schematic view of a NAND flash storage chip checking method in accordance with the first embodiment of the present invention.

FIG. 5 is a structure diagram of a NAND flash storage chip checking device in accordance with the second embodiment of the present invention.

### DETAILED DESCRIPTION OF THE PREFERRED EMBODIMENTS

In order to make the technical solutions and advantages of the present invention are more apparent, reference will now be made in detail to the present invention in conjunction with the embodiment and the accompanying drawings. It will be understood that the embodiments described below are not intended to limit the invention. The alternatives, modifications and equivalents made within the spirit and scope of the invention are all included within the scope of the invention.

### A First Embodiment

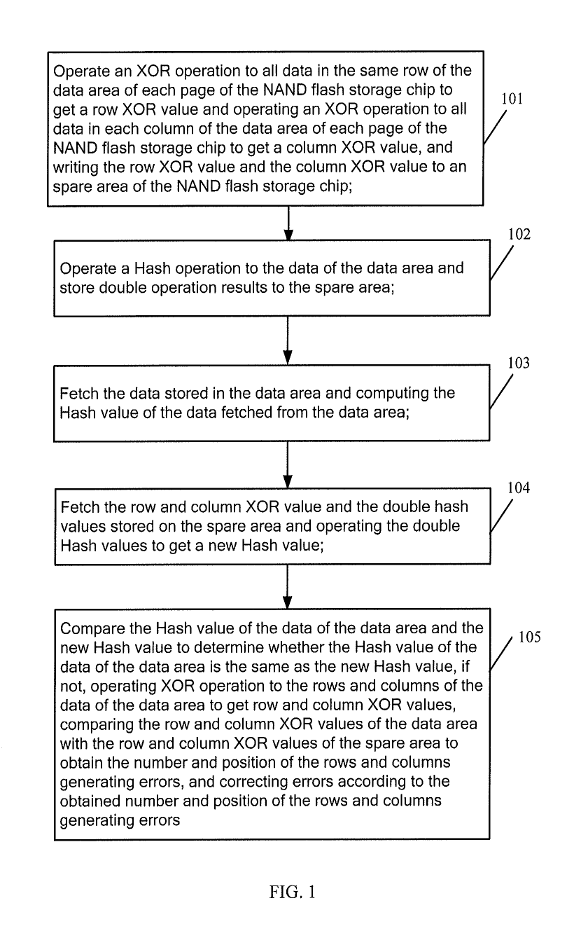

FIG. 1 is a flow chart of a NAND flash storage chip checking method in accordance with the first embodiment of the present invention. The method includes the following steps:

Step 101, operating an XOR operation to all the data in each row of the data area of each page of the NAND flash storage chip to get a row XOR value and operating an XOR operation to all the data in each column of the data area of each page of the NAND flash storage chip to get a column XOR value, and writing the row XOR value and the column XOR value to an spare area of the NAND flash storage chip.

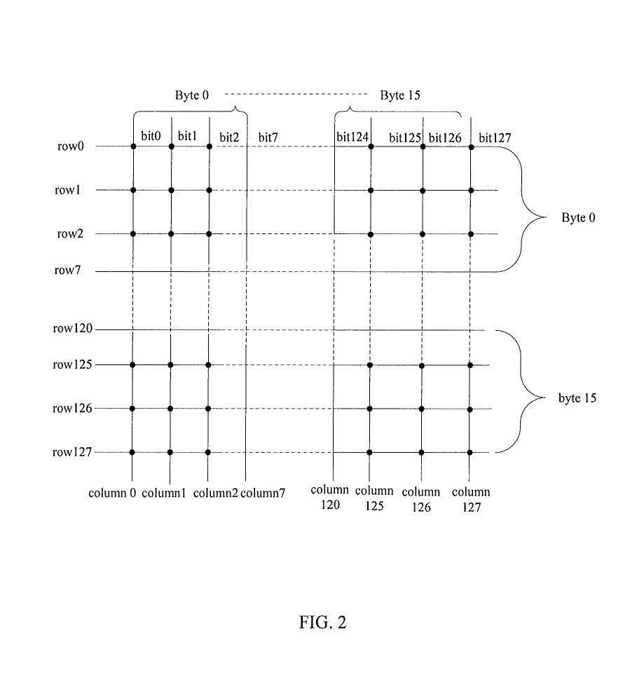

Specifically, referring to FIG. 2, each page of the NAND flash has 2K bytes, namely 16K bits which are arranged as a 128*128 matrix. The XOR operation is carried out to each row of the matrix to get the row XOR value, thereby 128 bits, namely 16 bytes, are needed to record all the row XOR values. Similarly, 16 bytes are also needed to record all the column XOR values. Therefore, 32 bytes are needed to record the row XOR values and the column XOR values.

Specifically, operating the row XOR value is to carry out the XOR operation to the data of first bit and the second data of each row to get a first XOR value, and then carry out the XOR operation to the first XOR value and the data of the third bit, which is in the same row with the first bit and the second bit, to get a second XOR value, and then carry out the XOR operation to the second XOR value and the data of the fourth bit, which is also in the same row with the first bit and the second bit, to get the third XOR value, and then carry out the XOR operation to the third XOR value and the data of the fifth bit, which is also in the same row with the first bit and the second bit, and so on, to carry out the XOR operation to the data of 128 bit of each row to get the row XOR value of each row. Thereby, 128 row XOR values and 128 column XOR values are got from the 128*128 matrix and 32 bytes storage space are needed to store the 128 row XOR values and 128 column XOR values.

The method further includes: step 102, operating the Hash operation to the data in the data area get a Hash value and double store the Hash value to the spare area.

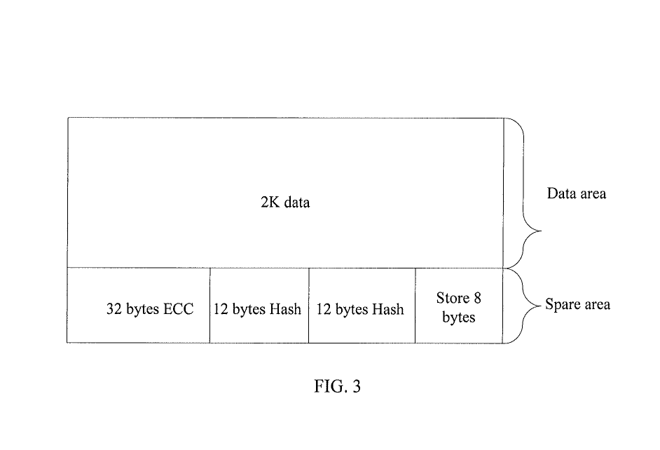

Specifically, the size of the Hash value for computing the data in the data area is 20 bytes. When writing the data, the 32 bytes XOR value is written to the spare area, and the first 12 bytes of the computed Hash value is repeatedly written to the spare area, as shown in FIG. 3. Wherein, only writing the first 12 bytes of the computed Hash value is considered from the storage capacity, the repeatedly writing of the first 12 bytes of the computed Hash value is considered from the unstablity of the storage chip. The double stored hash value can be used to compute a new hash value in case of the error caused by the unstablity of the storage chip.

The method further includes: the step 103, fetching the data stored in the data area and computing the Hash value of the data fetched from the data area;

Step S104, fetching the row and column XOR value and the double stored hash values and operating the double stored hash values to get the new Hash value.

Specifically, comparing the double stored hash value, if the Hash value in the same row and column of the double stored hash values both are “0”, the new hash value in the row and column is “1”, otherwise, the new Hash value in the row and column is “1”, thus the new Hash value is gotten.

The method further includes step 105, comparing the Hash value of the data in the data area and the new Hash value to determine whether the Hash value of the data in the data area is the same as the new Hash value, if not, operating XOR operation to the row and column of the data in the data area to get the row and column XOR value in the data area and operating XOR operation to the rows and columns of the data in the data area to get row and column XOR values in the spare area, comparing the row and column XOR value of the data area with the row and column XOR value of the spare area to obtain the number and the position of the rows and columns generating errors, and correcting errors according to the number and the position of the row and column generating errors.

Specifically, operating the XOR operation to row and column of the data in the data area to get the row and column XOR value when the Hash value of the data in the data area is different from the new hash data, and comparing the row and column XOR value of the data area with the row and column XOR value of the spare area, for example, the computed XOR value of the first row of the data area compares the stored XOR value of the first row of the spare area, if the computed XOR value of the first row is different from the stored XOR value of the first row, it is determined that this row generates errors, namely it is obtained the first row is the row generating errors. Similarly, the number and position of the rows and columns generating errors can be obtained. If the number of the rows or columns generating errors is greater than 2, error is returned. If the number of the rows or columns generating errors is equal or less than 2, errors are corrected according to the numbers and position of the rows and columns generating errors.

As a preferred example, if the Hash value of the data in the data area is the same as the new Hash value, right is returned.

As another preferred example, if the number of the rows or columns generating errors is greater than 2, error is returned.

In a first preferred example, correcting errors according to the numbers and positions of the rows and columns generating errors further includes:

If the number of the column generating errors is 0 and the number of the row generating errors is 1, the position of the row generating errors can be determined by the coordinates where the row generating errors locates;

After inverting the data of the row generating errors from the first bit according to a predetermined turn, computing the Hash value of all the data in the data area. If the computed Hash value is the same as the new Hash value, right is retuned and keep the data of the row generating errors being inverted from the first bit according to a predetermined turn.

If the computed Hash value is different from the new Hash value, recovering the data of the row generating errors being inverted from the first bit according to a predetermined turn to the original data. The original data is the data of the first row that are not inverted from the first bit according to a predetermined turn.

After inverting the data of the row generating errors from the next bit of the first bit according to a predetermined turn, computing the Hash value of all the data in the data area. If the computed Hash value is the same as the new Hash value, right is retuned and keep the data of the row generating errors being inverted from the next bit of the first bit according to a predetermined turn.

If the computed Hash value is different from the new Hash value, recovering the data of the row generating errors being inverted from the next bit of the first bit according to a predetermined turn to the original data. The original data is the data of the first row that are not inverted from the next bit of the first bit according to a predetermined turn, and the rest may be deduced by analogy.

Based on the first preferred example, as another preferred example, the method further includes:

After the data of all the bits of the row generating errors are inverted in turn, if the computed Hash value is different from the new Hash value, the error is returned.

In a second preferred example, correcting errors according to the numbers and positions of the rows and columns generating errors further includes:

determining the position of the two rows generating errors according to the coordinates where the two rows generating errors locate if the number of the column generating errors is 0 and the number of the rows generating errors is 2;

inverting the data of two bits of one of the columns of the two rows generating errors, computing Hash value of the data in the data area, returning right and keeping the inverted data of the two bits of one of the columns of the two rows generating errors if the computed Hash value is the same as the new Hash value;

recovering the inverted data of the two bits of one of the columns of the two rows generating errors to original data if the computed Hash value is different from the new Hash value, the original data is the two bits of one of the columns of the two rows generating errors being not inverted;

inverting the data of two bits of the next column of the one of the columns of the two rows generating errors, computing Hash value of the data in the data area, returning right and keeping the inverted data of the two bits of the next column of the one of the columns of the two rows generating errors if the computed Hash value is the same as the new Hash value;

recovering the inverted data of the two bits of the next column of the one of the columns of the two rows generating errors to original data if the computed Hash value is different from the new Hash value, the original data is the two bits of the next column of the one of the columns of the two rows generating errors being not inverted, and the rest may be deduced by analogy.

Based on the second preferred example and as another preferred example, the method further comprises: returning wrong if the computed Hash value is different from the new Hash value after the data of all the bits of the two rows generating errors are inverted in turn.

In a third preferred embodiment, correcting errors according to the number and the position of the rows and columns generating errors further comprises:

determining the position of the column generating errors according to the coordinates where the column generating errors locates if the number of the column generating errors is 1 and the number of the column generating errors is 0;

computing the Hash value of all the data in the data area after inverting the data of the column generating errors from the first bit according to a predetermined turn; returning right and keeping the data of the column generating errors being inverted from the first bit according to a predetermined turn if the computed Hash value is the same as the new Hash value;

recovering the data of the column generating errors being inverted from the first bit according to a predetermined turn to the original data, the original data is the data of the first column that are not inverted from the first bit according to a predetermined turn;

computing the Hash value of all the data in the data area after inverting the data of the column generating errors from the next bit of the first bit according to a predetermined turn, returning right and keeping the data of the column generating errors being inverted from the next bit of the first bit according to a predetermined turn if the computed Hash value is the same as the new Hash value;

recovering the data of the column generating errors being inverted from the next bit of the first bit according to a predetermined turn to the original data if the computed Hash value is different from the new Hash value, the original data is the data of the first column that are not inverted from the next bit of the first bit according to a predetermined turn, and the rest may be deduced by analogy.

Based on the third preferred example and as another preferred example, the method further comprises:

returning wrong if the computed Hash value is different from the new Hash value after the data of all the bits of the column generating errors are inverted in turn.

In a fourth preferred example, correcting errors according to the number and the position of the rows and columns generating errors further comprises:

determining the positions of the column generating errors and the row generating errors according to the coordinates where the row and column generating errors locate if the number of the column generating errors is 1 and the number of the columns generating errors is 1;

inverting the data in the determined position of the column generating errors and the row generating errors, computing Hash value of the data in the data area, returning right and keeping the inverted data of the data in the determined position of the column generating errors and the row generating errors if the computed Hash value is the same as the new Hash value;

returning wrong if the computed Hash value is different from the new Hash value.

In a fifth preferred example, correcting errors according to the number and the position of the rows and columns generating errors further comprises:

executing the steps being executed when the number of the column generating errors is 0 and the number of the rows generating errors is 2 if the number of the column generating errors is 1 and the number of the rows generating errors is 2 and the data of the two rows generating errors exist in the column generating errors;

executing the steps being executed when the number of the column generating errors is 0 the and the number of the rows generating errors is 2 if the number of the column generating errors is 1 and the number of the rows generating errors is 2 and the data of one bit of one of the two rows generating errors is error and the data of the position of a corresponding point of the other one of the two rows generating errors and the column generating errors.

In a sixth preferred example, correcting errors according to the number and the position of the rows and columns generating errors further comprises:

determining the position of the two rows generating errors according to the coordinates where the two rows generating errors locate if the number of the columns generating errors is 2 and the number of the row generating errors is 0;

inverting the data of two bits of one of the rows of the two columns generating errors, computing Hash value of the data in the data area, returning right and keeping the inverted data of the two bits of one of the rows of the two columns generating errors if the computed Hash value is the same as the new Hash value;

recovering the inverted data of the two bits of one of the rows of the two columns generating errors to original data if the computed Hash value is different from the new Hash value, the original data is the two bits of one of the rows of the two columns generating errors being not inverted;

inverting the data of two bits of the next row of the one of the rows of the two rows generating errors, computing Hash value of the data in the data area, returning right and keeping the inverted data of the two bits of the next row of the one of the rows of the two rows generating errors if the computed Hash value is the same as the new Hash value;

recovering the inverted data of the two bits of the next row of the one of the rows of the two columns generating errors to original data if the computed Hash value is different from the new Hash value, the original data is the two bits of the next row of the one of the rows of the two columns generating errors being not inverted, and the rest may be deduced by analogy.

Based on the sixth preferred embodiment and as another preferred example, the method further comprises: returning wrong if the computed Hash value is different from the new Hash value after the data of all the bits of the two columns generating errors are inverted in turn.

In a seventh preferred embodiment, correcting errors according to the number and the position of the rows and columns generating errors further comprises:

executing the steps being executed when the number of the column generating errors is 2 and the number of the row generating errors is 0 if the number of the columns generating errors is 2 and the number of the row generating errors is 1 and the data of the two columns generating errors exist in the row generating errors;

executing the steps being executed when the number of the column generating errors is 1 the and the number of the rows generating errors is 0 if the number of the column generating errors is 2 and the number of the row generating errors is 1 and the data of one bit of one of the two columns generating errors is error and the data of the position of a corresponding point of the other one of the two columns generating errors and the row generating errors.

In an eighth preferred example, correcting errors according to the number and the position of the rows and columns generating errors comprises:

inverting the corresponding data of the coordinates of an intersection point of the first row generating errors and the first column generating errors locate and the corresponding data of the coordinates of an intersection point of the second row generating errors and the second column generating errors if the number of the column generating errors is 2 and the number of the row generating errors is 2, computing Hash value of the data in the data area, returning right and keeping the inverted data of data in the coordinates of the intersection point of the first row generating errors and the first column generating errors and the corresponding data of the coordinates of the intersection point of the second row generating errors and the second column generating errors; returning wrong if the computed Hash value is different from the new Hash value;

inverting the corresponding data of the coordinates of an intersection point of the first row generating errors and the second column generating errors locate and the corresponding data of an intersection point of the second row generating errors and the first column generating errors if the number of the column generating errors is 2 and the number of the row generating errors is 2, computing Hash value of the data in the data area, returning right and keeping the inverted data of data in the coordinates of an intersection point of the first row generating errors and the second column generating errors and the corresponding data of the coordinates of an intersection point of the second row generating errors and the first column generating errors; returning wrong if the computed Hash value is different from the new Hash value.

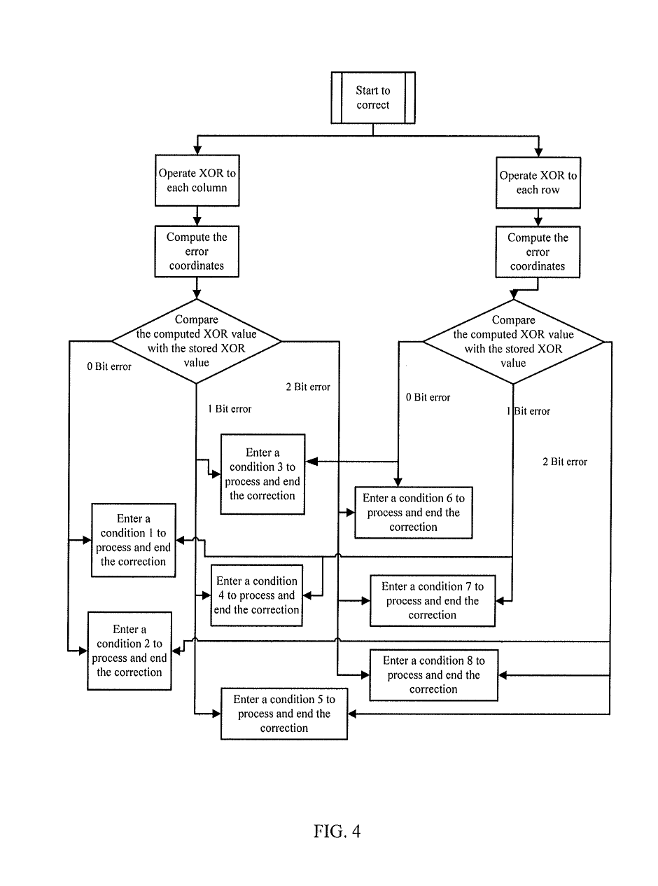

The method can specifically refer to the method schematic diagram shown in FIG. 4.

As another preferred example, the method returns a number of bits of errors after all the steps of the method is executed but the errors cannot be corrected.

The provided correcting method for the NAND flash storage chip can correct one or two bits errors and find a number of bits errors according to the row and column XOR value and Hash value of each page written into the spare area, comparing the data stored in the data area and the computed Hash value of data area to correct one or two bits of errors, thus ensures the accuracy and integrity of the data stored in the NAND Flash chip and reduces the risk of crash of the file system.

### A Second Embodiment

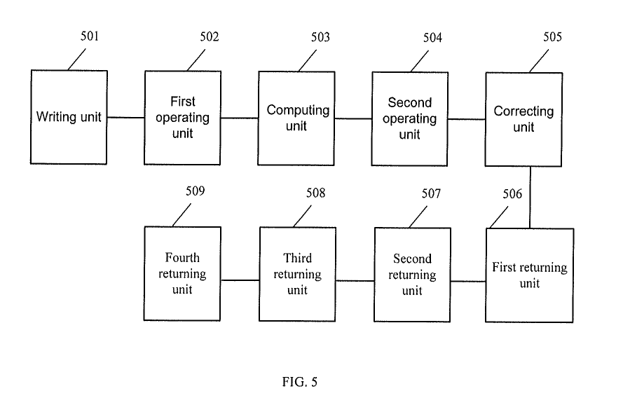

FIG. 5 is a structure diagram of the NAND flash storage chip correcting device according to a first embodiment of the present invention. The device includes:

a writing unit 501 for operating an XOR operation to all the data in each row of the data area of each page of the NAND flash storage chip to get a row XOR value and operating an XOR operation to all the data in each column of the data area of each page of the NAND flash storage chip to get a column XOR value, and writing the row XOR value and the column XOR value to an spare area of the NAND flash storage chip.

Specifically, referring to FIG. 2, each page of the NAND flash has 2K bytes, namely 16K bits which are arranged as a 128*128 matrix. The XOR operation is carried out to each row of the matrix to get the row XOR value, thereby 128 bits, namely 16 bytes, are needed to record all the row XOR values. Similarly, 16 bytes are also needed to record all the column XOR values. Therefore, 32 bytes are needed to record the row XOR values and the column XOR values.

a first operating unit is for operating the Hash operation to the data in the data area to get a Hash value and double store the Hash value to the spare area.

Specifically, the size of the Hash value for computing the data in the data area is 20 bytes. When writing the data, the 32 bytes XOR value is written to the spare area, and the first 12 bytes of the computed Hash value is repeatedly written to the spare area, as shown in FIG. 3. Wherein, only writing the first 12 bytes of the computed Hash value is considered from the storage capacity, the repeatedly writing of the first 12 bytes of the computed Hash value is considered from the unstablity of the storage chip. The double stored hash value can be used to compute a new hash value in case of the error caused by the unstablity of the storage chip.

a computing unit 503 is for fetching the data stored in the data area and computing the Hash value of the data fetched from the data area;

a second operating unit 504 is for fetching the row and column XOR value and the double stored hash values and operating the double stored hash values to get the new Hash value.

Specifically, comparing the double stored hash value, if the Hash value in the same row and column of the double stored hash values both are “0”, the new hash value in the row and column is “1”, otherwise, the new Hash value in the row and column is “1”, thus the new Hash value is gotten.

a correcting unit is for comparing the Hash value of the data in the data area and the new Hash value to determine whether the Hash value of the data in the data area is the same as the new Hash value, if not, operating XOR operation to the row and column of the data in the data area to get the row and column XOR value in the data area and operating XOR operation to the rows and columns of the data in the data area to get row and column XOR values in the spare area, comparing the row and column XOR value in the data area with the row and column XOR value in the spare area to obtain the number and the position of the rows and columns generating errors, and correcting errors according to the number and the position of the row and column generating errors.

Specifically, operating the XOR operation to row and column of the data in the data area to get the row and column XOR value when the Hash value of the data in the data area is different from the new hash data, and comparing the row and column XOR value of the data area with the row and column XOR value of the spare area, for example, the computed XOR value of the first row of the data area compares the stored XOR value of the first row of the spare area, if the computed XOR value of the first row is different from the stored XOR value of the first row, it is determined that this row generates errors, namely it is obtained the first row is the row generating errors. Similarly, the number and position of the rows and columns generating errors can be obtained. If the number of the rows or columns generating errors is greater than 2, error is returned. If the number of the rows or columns generating errors is equal or less than 2, errors are corrected according to the numbers and position of the rows and columns generating errors.

As a preferred example, the device further includes a returning unit. The returning unit is for returning right if the Hash value of the data in the data area is the same as the new Hash value.

As another preferred example, the returning unit includes returning wrong if the number of the rows or columns generating errors is greater than 2.

In a first preferred example, the correcting unit 505 includes:

determining the position of the row generating errors according to the coordinates where the row generating errors locates if the number of the column generating errors is 0 and the number of the row generating errors is 1.

computing the Hash value of all the data in the data area after inverting the data of the row generating errors from the first bit according to a predetermined turn. If the computed Hash value is the same as the new Hash value, right is retuned and keep the data of the row generating errors being inverted from the first bit according to a predetermined turn.

If the computed Hash value is different from the new Hash value, recovering the data of the row generating errors being inverted from the first bit according to a predetermined turn to the original data. The original data is the data of the first row that are not inverted from the first bit according to a predetermined turn.

After inverting the data of the row generating errors from the next bit of the first bit according to a predetermined turn, computing the Hash value of all the data in the data area. If the computed Hash value is the same as the new Hash value, right is retuned and keep the data of the row generating errors being inverted from the next bit of the first bit according to a predetermined turn.

If the computed Hash value is different from the new Hash value, recovering the data of the row generating errors being inverted from the next bit of the first bit according to a predetermined turn to the original data. The original data is the data of the first row that are not inverted from the next bit of the first bit according to a predetermined turn, and the rest may be deduced by analogy.

Based on the first preferred example, as another preferred example, the device further includes a first returning unit 506, the first returning unit 506 includes:

returning wrong if the computed Hash value is different from the new Hash value after the data of all the bits of the row generating errors are inverted in turn.

In a second preferred example, the correcting unit 505 further includes:

determining the position of the two rows generating errors according to the coordinates where the two rows generating errors locate if the number of the column generating errors is 0 and the number of the rows generating errors is 2;

inverting the data of two bits of one of the columns of the two rows generating errors, computing Hash value of the data in the data area, returning right and keeping the inverted data of the two bits of one of the columns of the two rows generating errors if the computed Hash value is the same as the new Hash value;

recovering the inverted data of the two bits of one of the columns of the two rows generating errors to original data if the computed Hash value is different from the new Hash value, the original data is the two bits of one of the columns of the two rows generating errors being not inverted;

inverting the data of two bits of the next column of the one of the columns of the two rows generating errors, computing Hash value of the data in the data area, returning right and keeping the inverted data of the two bits of the next column of the one of the columns of the two rows generating errors if the computed Hash value is the same as the new Hash value;

recovering the inverted data of the two bits of the next column of the one of the columns of the two rows generating errors to original data if the computed Hash value is different from the new Hash value, the original data is the two bits of the next column of the one of the columns of the two rows generating errors being not inverted, and the rest may be deduced by analogy.

Based on the second preferred example and as another preferred example, the device further comprises a second returning unit 507. The second returning unit 507 comprises:

returning wrong if the computed Hash value is different from the new Hash value after the data of all the bits of the row generating errors are inverted in turn.

In a third preferred embodiment, the correcting unit 505 further comprises:

determining the position of the column generating errors according to the coordinates where the column generating errors locates if the number of the column generating errors is 1 and the number of the column generating errors is 0;

computing the Hash value of all the data in the data area after inverting the data of the column generating errors from the first bit according to a predetermined turn; returning right and keeping the data of the column generating errors being inverted from the first bit according to a predetermined turn if the computed Hash value is the same as the new Hash value;

recovering the data of the column generating errors being inverted from the first bit according to a predetermined turn to the original data, the original data is the data of the first column that are not inverted from the first bit according to a predetermined turn;

computing the Hash value of all the data in the data area after inverting the data of the column generating errors from the next bit of the first bit according to a predetermined turn, returning right and keeping the data of the column generating errors being inverted from the next bit of the first bit according to a predetermined turn if the computed Hash value is the same as the new Hash value;

recovering the data of the column generating errors being inverted from the next bit of the first bit according to a predetermined turn to the original data if the computed Hash value is different from the new Hash value, the original data is the data of the first column that are not inverted from the next bit of the first bit according to a predetermined turn, and the rest may be deduced by analogy.

Based on the third preferred example and as another preferred example, the device further includes a third returning unit 508, the third returning unit 508 further includes:

returning wrong if the computed Hash value is different from the new Hash value after the data of all the bits of the column generating errors are inverted in turn.

In a fourth preferred example, the correcting unit 505 further comprises:

determining the positions of the column generating errors and the row generating errors according to the coordinates where the row and column generating errors locate if the number of the column generating errors is 1 and the number of the columns generating errors is 1;

inverting the data in the determined position of the column generating errors and the row generating errors, computing Hash value of the data in the data area, returning right and keeping the inverted data of the data in the determined position of the column generating errors and the row generating errors if the computed Hash value is the same as the new Hash value;

returning wrong if the computed Hash value is different from the new Hash value.

In a fifth preferred example, the correcting unit 505 includes:

executing the steps being executed when the number of the column generating errors is 0 and the number of the rows generating errors is 2 if the number of the column generating errors is 1 and the number of the rows generating errors is 2 and the data of the two rows generating errors exist in the column generating errors;

executing the steps being executed when the number of the column generating errors is 0 the and the number of the rows generating errors is 2 if the number of the column generating errors is 1 and the number of the rows generating errors is 2 and the data of one bit of one of the two rows generating errors is error and the data of the position of a corresponding point of the other one of the two rows generating errors and the column generating errors.

In a sixth preferred example, the correcting unit 506 (505) includes:

determining the position of the two rows generating errors according to the coordinates where the two rows generating errors locate if the number of the columns generating errors is 2 and the number of the row generating errors is 0;

inverting the data of two bits of one of the rows of the two columns generating errors, computing Hash value of the data in the data area, returning right and keeping the inverted data of the two bits of one of the rows of the two columns generating errors if the computed Hash value is the same as the new Hash value;

recovering the inverted data of the two bits of one of the rows of the two columns generating errors to original data if the computed Hash value is different from the new Hash value, the original data is the two bits of one of the rows of the two columns generating errors being not inverted;

inverting the data of two bits of the next row of the one of the rows of the two rows generating errors, computing Hash value of the data in the data area, returning right and keeping the inverted data of the two bits of the next row of the one of the rows of the two rows generating errors if the computed Hash value is the same as the new Hash value;

recovering the inverted data of the two bits of the next row of the one of the rows of the two columns generating errors to original data if the computed Hash value is different from the new Hash value, the original data is the two bits of the next row of the one of the rows of the two columns generating errors being not inverted, and the rest may be deduced by analogy.

Based on the sixth preferred embodiment and as another preferred example, the device further includes a fourth returning unit 509, the fourth returning unit 509 includes:

returning wrong if the computed Hash value is different from the new Hash value after the data of all the bits of the two columns generating errors are inverted in turn.

In a seventh preferred embodiment, the correcting unit 505 includes:

executing the steps being executed when the number of the column generating errors is 2 and the number of the row generating errors is 0 if the number of the columns generating errors is 2 and the number of the row generating errors is 1 and the data of the two columns generating errors exist in the row generating errors;

executing the steps being executed when the number of the column generating errors is 1 the and the number of the rows generating errors is 0 if the number of the column generating errors is 2 and the number of the row generating errors is 1 and the data of one bit of one of the two columns generating errors is error and the data of the position of a corresponding point of the other one of the two columns generating errors and the row generating errors.

In an eighth preferred example, the correcting unit includes:

inverting the corresponding data of the coordinates an intersection point of the first row generating errors and the first column generating errors and the corresponding data of the coordinates of an intersection point of the second row generating errors and the second column generating errors if the number of the column generating errors is 2 and the number of the row generating errors is 2, computing Hash value of the data in the data area, returning right and keeping the inverted data of data in the coordinates of the intersection point of the first row generating errors and the first column generating errors and the corresponding data of the coordinates of the intersection point of the second row generating errors and the second column generating errors; returning wrong if the computed Hash value is different from the new Hash value;

inverting the corresponding data of the coordinates of an intersection point of the first row generating errors and the second column generating errors locate and the corresponding data of an intersection point of the second row generating errors and the first column generating errors if the number of the column generating errors is 2 and the number of the row generating errors is 2, computing Hash value of the data in the data area, returning right and keeping the inverted data of data in the coordinates of an intersection point of the first row generating errors and the second column generating errors and the corresponding data of the coordinates of an intersection point of the second row generating errors and the first column generating errors; returning wrong if the computed Hash value is different from the new Hash value.

Specifically, the method schematic diagram shown in FIG. 4 can be referred to specify the method.

As another preferred example, the method returns a number of bits of errors after all the steps of the method is executed but the errors cannot be corrected.

The provided correcting device for the NAND flash storage chip can correct one or two bits errors and find a number of bits errors according to the row and column XOR value and Hash value of each page written into the spare area, comparing the data stored in the data area and the computed Hash value of data area to correct one or two bits of errors, thus ensures the accuracy and integrity of the data stored in the NAND Flash chip and reduces the risk of crash of the file system.

Finally, it is needed to explain that the above embodiments are only used to describe the technical solution of the present invention. The person skilled in this art should be understood that the technical solution described in the above embodiments can be amended, or some of or all the features thereof can be equivalently replaced. The amendments and the replacements can not make the nature of the corresponding technical solution break away from the scope of the technical solution of the embodiments of the present invention.

1. A NAND flash storage chip checking method, comprising:
operating an XOR operation to all data in the same row of the data area of each page of the NAND flash storage chip to get a row XOR value and operating an XOR operation to all data in each column of the data area of each page of the NAND flash storage chip to get a column XOR value, and writing the row XOR value and the column XOR value to an spare area of the NAND flash storage chip;
operating a Hash operation to the data in the data area to get a Hash value and double store the Hash value results to the spare area;
fetching the data stored in the data area and computing the Hash value of the data fetched from the data area;
fetching the row and column XOR value and the double stored hash values stored on the spare area and operating the double stored hash values to get a new Hash value;
comparing the Hash value of the data in the data area and the new Hash value to determine whether the Hash value of the data in the data area is the same as the new Hash value, if not, operating XOR operation to the rows and columns of the data in the data area to get row and column XOR values in the data area and operating XOR operation to the rows and columns of the data in the data area to get row and column XOR values in the spare area, comparing the row and column XOR values of the data area with the row and column XOR values of the spare area to obtain the number and position of the rows and columns generating errors, and correcting errors according to the obtained number and position of the rows and columns generating errors.

2. The method as claimed in claim 1, further comprising: returning right if the Hash value of the data in the data area is the same as the new Hash value.

3. The method as claimed in claim 1, further comprising: returning wrong if the number of the rows or columns generating errors is larger than 2.

4. The method as claimed in claim 3, wherein operating the double stored hash values to get the new Hash value further comprises: comparing the double stored hash values, if the Hash value in the same row and column of the double stored hash values both are “0”, the new hash value in the same row and column is “1”, otherwise, the new Hash value in the same row and column is “1”, thus to get the new Hash value.

5. The method as claimed in claim 4, wherein correcting errors according to the number and the position of the rows and columns generating errors further comprises:
the position of the row generating errors can be determined by the coordinates where the row generating errors locates if the number of the column generating errors is 0 and the number of the row generating errors is 1;
computing the Hash value of all the data in the data area after inverting the data of the row generating errors from the first bit according to a predetermined turn; returning right and keeping the data of the row generating errors being inverted from the first bit according to a predetermined turn if the computed Hash value is the same as the new Hash value;
recovering the data of the row generating errors being inverted from the first bit according to a predetermined turn to the original data, the original data is the data of the first row that are not inverted from the first bit according to a predetermined turn.
computing the Hash value of all the data in the data area after inverting the data of the row generating errors from the next bit of the first bit according to a predetermined turn, returning right and keeping the data of the row generating errors being inverted from the next bit of the first bit according to a predetermined turn if the computed Hash value is the same as the new Hash value;
recovering the data of the row generating errors being inverted from the next bit of the first bit according to a predetermined turn to the original data if the computed Hash value is different from the new Hash value, the original data is the data of the first row that are not inverted from the next bit of the first bit according to a predetermined turn, and the rest may be deduced by analogy.

6. The method as claimed in claim 5, further comprising:
returning wrong if the computed Hash value is different from the new Hash value after the data of all the bits of the row generating errors are inverted in turn.

7. The method as claimed in claim 4, wherein correcting errors according to the number and the position of the rows and columns generating errors further comprises:
determining the position of the two rows generating errors according to the coordinates where the two rows generating errors locate if the number of the column generating errors is 0 and the number of the rows generating errors is 2;
inverting the data of two bits of one of the columns of the two rows generating errors, computing Hash value of the data in the data area, returning right and keeping the inverted data of the two bits of one of the columns of the two rows generating errors if the computed Hash value is the same as the new Hash value;
recovering the inverted data of the two bits of one of the columns of the two rows generating errors to original data if the computed Hash value is different from the new Hash value, the original data is the two bits of one of the columns of the two rows generating errors being not inverted;
inverting the data of two bits of the next column of the one of the columns of the two rows generating errors, computing Hash value of the data in the data area, returning right and keeping the inverted data of the two bits of the next column of the one of the columns of the two rows generating errors if the computed Hash value is the same as the new Hash value;
recovering the inverted data of the two bits of the next column of the one of the columns of the two rows generating errors to original data if the computed Hash value is different from the new Hash value, the original data is the two bits of the next column of the one of the columns of the two rows generating errors being not inverted, and the rest may be deduced by analogy.

8. The method as claimed in claim 7, further comprising: returning wrong if the computed Hash value is different from the new Hash value after the data of all the bits of the two rows generating errors are inverted in turn.

9. The method as claimed in claim 4, wherein correcting errors according to the number and the position of the rows and columns generating errors further comprises:
determining the position of the column generating errors according to the coordinates where the column generating errors if the number of the column generating errors is 1 and the number of the column generating errors is 0;
computing the Hash value of all the data in the data area after inverting the data of the column generating errors from the first bit according to a predetermined turn; returning right and keeping the data of the column generating errors being inverted from the first bit according to a predetermined turn if the computed Hash value is the same as the new Hash value;
recovering the data of the column generating errors being inverted from the first bit according to a predetermined turn to the original data, the original data is the data of the first column that are not inverted from the first bit according to a predetermined turn;
computing the Hash value of all the data in the data area after inverting the data of the column generating errors from the next bit of the first bit according to a predetermined turn, returning right and keeping the data of the column generating errors being inverted from the next bit of the first bit according to a predetermined turn if the computed Hash value is the same as the new Hash value;
recovering the data of the column generating errors being inverted from the next bit of the first bit according to a predetermined turn to the original data if the computed Hash value is different from the new Hash value, the original data is the data of the first column that are not inverted from the next bit of the first bit according to a predetermined turn, and the rest may be deduced by analogy.

10. The method as claimed in claim 9, further comprising:
returning wrong if the computed Hash value is different from the new Hash value after the data of all the bits of the column generating errors are inverted in turn.

11. The method as claimed in claim 4, wherein correcting errors according to the number and the position of the rows and columns generating errors further comprises:
determining the positions of the column generating errors and the row generating errors according to the coordinates where the row and column generating errors locates if the number of the column generating errors is 1 and the number of the columns generating errors is 1;
inverting the data in the determined position of the column generating errors and the row generating errors, computing Hash value of the data in the data area, returning right and keeping the inverted data of the data in the determined position of the column generating errors and the row generating errors if the computed Hash value is the same as the new Hash value;
returning wrong if the computed Hash value is different from the new Hash value.

12. The method as claimed in claim 11, wherein correcting errors according to the number and the position of the rows and columns generating errors further comprises:
executing the steps being executed when the number of the column generating errors is 0 and the number of the rows generating errors is 2 if the number of the column generating errors is 1 and the number of the rows generating errors is 2 and the data of the two rows generating errors exist in the column generating errors;
executing the steps being executed when the number of the column generating errors is 0 the and the number of the rows generating errors is 2 if the number of the column generating errors is 1 and the number of the rows generating errors is 2 and the data of one bit of one of the two rows generating errors is error and the data of the position of a corresponding point of the other one of the two rows generating errors and the column generating errors.

13. The method as claimed in claim 4, wherein correcting errors according to the number and the position of the rows and columns generating errors further comprises:
determining the position of the two rows generating errors according to the coordinates where the two rows generating errors locate if the number of the columns generating errors is 2 and the number of the row generating errors is 0;
inverting the data of two bits of one of the rows of the two columns generating errors, computing Hash value of the data in the data area, returning right and keeping the inverted data of the two bits of one of the rows of the two columns generating errors if the computed Hash value is the same as the new Hash value;
recovering the inverted data of the two bits of one of the rows of the two columns generating errors to original data if the computed Hash value is different from the new Hash value, the original data is the two bits of one of the rows of the two columns generating errors being not inverted;
inverting the data of two bits of the next row of the one of the rows of the two rows generating errors, computing Hash value of the data in the data area, returning right and keeping the inverted data of the two bits of the next row of the one of the rows of the two rows generating errors if the computed Hash value is the same as the new Hash value;
recovering the inverted data of the two bits of the next row of the one of the rows of the two columns generating errors to original data if the computed Hash value is different from the new Hash value, the original data is the two bits of the next row of the one of the rows of the two columns generating errors being not inverted, and the rest may be deduced by analogy.

14. The method as claimed in claim 13, further comprising: returning wrong if the computed Hash value is different from the new Hash value after the data of all the bits of the two columns generating errors are inverted in turn.

15. The method as claimed in claim 4, wherein correcting errors according to the number and the position of the rows and columns generating errors further comprises:
executing the steps being executed when the number of the column generating errors is 2 and the number of the row generating errors is 0 if the number of the columns generating errors is 2 and the number of the row generating errors is 1 and the data of the two columns generating errors exist in the row generating errors;
executing the steps being executed when the number of the column generating errors is 1 the and the number of the rows generating errors is 0 if the number of the column generating errors is 2 and the number of the row generating errors is 1 and the data of one bit of one of the two columns generating errors is error and the data of the position of a corresponding point of the other one of the two columns generating errors and the row generating errors.

16. The method as claimed in claim 4, wherein correcting errors according to the number and the position of the rows and columns generating errors further comprises:
inverting the corresponding data of the coordinates of an intersection point of the first row generating errors and the first column generating errors and the corresponding data of the coordinates of an intersection point of the second row generating errors and the second column generating errors if the number of the column generating errors is 2 and the number of the row generating errors is 2, computing Hash value of the data in the data area, returning right and keeping the inverted data of data in the coordinates of the intersection point of the first row generating errors and the first column generating errors and the corresponding data of the coordinates of the intersection point of the second row generating errors and the second column generating errors; returning wrong if the computed Hash value is different from the new Hash value;
inverting the corresponding data of the coordinates of an intersection point of the first row generating errors and the second column generating errors and the corresponding data of the coordinates of an intersection point of the second row generating errors and the first column generating errors if the number of the column generating errors is 2 and the number of the row generating errors is 2, computing Hash value of the data in the data area, returning right and keeping the inverted data of data in the coordinates of an intersection point of the first row generating errors and the second column generating errors and the corresponding data of the coordinates of an intersection point of the second row generating errors and the first column generating errors; returning wrong if the computed Hash value is different from the new Hash value.

17. A NAND flash storage chip checking device, comprising:
a writing unit for operating an XOR operation to all data in the same row of the data area of each page of the NAND flash storage chip to get a row XOR value and operating an XOR operation to all data in each column of the data area of each page of the NAND flash storage chip to get a column XOR value, and writing the row XOR value and the column XOR value to an spare area of the NAND flash storage chip;
a first operating unit for operating a Hash operation to the data in the data area to get a Hash value and double store the Hash value to the spare area;
a computing unit for fetching the data stored in the data area and computing the Hash value of the data fetched from the data area;
a second operating unit for fetching the row and column XOR value and the double stored hash values stored on the spare area and operating the double stored hash values to get a new Hash value;
a correcting unit for comparing the Hash value of the data in the data area and the new Hash value to determine whether the Hash value of the data in the data area is the same as the new Hash value, if not, operating XOR operation to the rows and columns of the data in the data area to get row and column XOR values in the data area and operating XOR operation to the rows and columns of the data in the data area to get row and column XOR values in the spare area, comparing the row and column XOR values of the data area with the row and column XOR values of the spare area to obtain the number and position of the rows and columns generating errors, and correcting errors according to the obtained number and position of the rows and columns generating errors.

18. The device as claimed in claim 17, further comprising a returning unit for returning right if the Hash value of the data in the data area is the same as the new Hash value.

19. The device as claimed in claim 17, wherein the returning unit further comprises further comprising:
returning wrong if the number of the rows or columns generating errors is larger than 2.

20. The device as claimed in claim 19, wherein the second operating unit comprises: comparing the double stored hash values, if the Hash value in the same row and column of the double stored hash values both are “0”, the new hash value in the same row and column is “1”, otherwise, the new Hash value in the same row and column is “1”, thus to get the new Hash value.

21. The device as claimed in claim 20, wherein the correcting unit comprises: determining the position of the row generating errors according to the coordinates where the row generating errors located if the number of the column generating errors is 0 and the number of the row generating errors is 1;
computing the Hash value of all the data in the data area after inverting the data of the row generating errors from the first bit according to a predetermined turn; returning right and keeping the data of the row generating errors being inverted from the first bit according to a predetermined turn if the computed Hash value is the same as the new Hash value;
recovering the data of the row generating errors being inverted from the first bit according to a predetermined turn to the original data, the original data is the data of the first row that are not inverted from the first bit according to a predetermined turn.
computing the Hash value of all the data in the data area after inverting the data of the row generating errors from the next bit of the first bit according to a predetermined turn, returning right and keeping the data of the row generating errors being inverted from the next bit of the first bit according to a predetermined turn if the computed Hash value is the same as the new Hash value;
recovering the data of the row generating errors being inverted from the next bit of the first bit according to a predetermined turn to the original data if the computed Hash value is different from the new Hash value, the original data is the data of the first row that are not inverted from the next bit of the first bit according to a predetermined turn, and the rest may be deduced by analogy.

22. The device as claimed in claim 21, further comprising a first returning unit, wherein the first returning unit comprises:
returning wrong if the computed Hash value is different from the new Hash value after the data of all the bits of the row generating errors are inverted in turn.

23. The device as claimed in claim 20, wherein the correcting unit comprises:
determining the position of the two rows generating errors according to the coordinates where the two rows generating errors locate if the number of the column generating errors is 0 and the number of the rows generating errors is 2;
inverting the data of two bits of one of the columns of the two rows generating errors, computing Hash value of the data in the data area, returning right and keeping the inverted data of the two bits of one of the columns of the two rows generating errors if the computed Hash value is the same as the new Hash value;
recovering the inverted data of the two bits of one of the columns of the two rows generating errors to original data if the computed Hash value is different from the new Hash value, the original data is the two bits of one of the columns of the two rows generating errors being not inverted;
inverting the data of two bits of the next column of the one of the columns of the two rows generating errors, computing Hash value of the data in the data area, returning right and keeping the inverted data of the two bits of the next column of the one of the columns of the two rows generating errors if the computed Hash value is the same as the new Hash value;
recovering the inverted data of the two bits of the next column of the one of the columns of the two rows generating errors to original data if the computed Hash value is different from the new Hash value, the original data is the two bits of the next column of the one of the columns of the two rows generating errors being not inverted, and the rest may be deduced by analogy.

24. The device as claimed in claim 23, further comprising a second returning unit, wherein the second returning unit comprises: returning wrong if the computed Hash value is different from the new Hash value after the data of all the bits of the two rows generating errors are inverted in turn.

25. The device as claimed in claim 20, wherein the correcting unit comprises:
determining the position of the column generating errors according to the coordinates where the column generating errors locates if the number of the column generating errors is 1 and the number of the column generating errors is 0;
computing the Hash value of all the data in the data area after inverting the data of the column generating errors from the first bit according to a predetermined turn; returning right and keeping the data of the column generating errors being inverted from the first bit according to a predetermined turn if the computed Hash value is the same as the new Hash value;
recovering the data of the column generating errors being inverted from the first bit according to a predetermined turn to the original data, the original data is the data of the first column that are not inverted from the first bit according to a predetermined turn.
computing the Hash value of all the data in the data area after inverting the data of the column generating errors from the next bit of the first bit according to a predetermined turn, returning right and keeping the data of the column generating errors being inverted from the next bit of the first bit according to a predetermined turn if the computed Hash value is the same as the new Hash value;
recovering the data of the column generating errors being inverted from the next bit of the first bit according to a predetermined turn to the original data if the computed Hash value is different from the new Hash value, the original data is the data of the first column that are not inverted from the next bit of the first bit according to a predetermined turn, and the rest may be deduced by analogy.

26. The device as claimed in claim 25, further comprising:
returning wrong if the computed Hash value is different from the new Hash value after the data of all the bits of the column generating errors are inverted in turn.

27. The device as claimed in claim 20, wherein the correcting unit comprises:
determining the positions of the column generating errors and the row generating errors according to the coordinates where the row and column generating errors locate if the number of the column generating errors is 1 and the number of the columns generating errors is 1;
inverting the data in the determined position of the column generating errors and the row generating errors, computing Hash value of the data in the data area, returning right and keeping the inverted data of the data in the determined position of the column generating errors and the row generating errors if the computed Hash value is the same as the new Hash value;
returning wrong if the computed Hash value is different from the new Hash value.

28. The device as claimed in claim 27, wherein the correcting unit comprises:
executing the steps being executed when the number of the column generating errors is 0 and the number of the rows generating errors is 2 if the number of the column generating errors is 1 and the number of the rows generating errors is 2 and the data of the two rows generating errors exist in the column generating errors;
executing the steps being executed when the number of the column generating errors is 0 the and the number of the rows generating errors is 2 if the number of the column generating errors is 1 and the number of the rows generating errors is 2 and the data of one bit of one of the two rows generating errors is error and the data of the position of a corresponding point of the other one of the two rows generating errors and the column generating errors.

29. The device as claimed in claim 20, wherein the correcting unit comprises:
determining the position of the two rows generating errors according to the coordinates where the two rows generating errors locate if the number of the columns generating errors is 2 and the number of the row generating errors is 0;
inverting the data of two bits of one of the rows of the two columns generating errors, computing Hash value of the data in the data area, returning right and keeping the inverted data of the two bits of one of the rows of the two columns generating errors if the computed Hash value is the same as the new Hash value;
recovering the inverted data of the two bits of one of the rows of the two columns generating errors to original data if the computed Hash value is different from the new Hash value, the original data is the two bits of one of the rows of the two columns generating errors being not inverted;
inverting the data of two bits of the next row of the one of the rows of the two rows generating errors, computing Hash value of the data in the data area, returning right and keeping the inverted data of the two bits of the next row of the one of the rows of the two rows generating errors if the computed Hash value is the same as the new Hash value;
recovering the inverted data of the two bits of the next row of the one of the rows of the two columns generating errors to original data if the computed Hash value is different from the new Hash value, the original data is the two bits of the next row of the one of the rows of the two columns generating errors being not inverted, and the rest may be deduced by analogy.

30. The device as claimed in claim 29, further comprising a fourth returning unit, wherein the fourth returning unit comprises:
returning wrong if the computed Hash value is different from the new Hash value after the data of all the bits of the two columns generating errors are inverted in turn.

31. The device as claimed in claim 20, wherein the correcting unit comprises:
executing the steps being executed when the number of the column generating errors is 2 and the number of the row generating errors is 0 if the number of the columns generating errors is 2 and the number of the row generating errors is 1 and the data of the two columns generating errors exist in the row generating errors;
executing the steps being executed when the number of the column generating errors is 1 the and the number of the rows generating errors is 0 if the number of the column generating errors is 2 and the number of the row generating errors is 1 and the data of one bit of one of the two columns generating errors is error and the data of the position of a corresponding point of the other one of the two columns generating errors and the row generating errors.

32. The device as claimed in claim 20, wherein the correcting unit comprises:
inverting the corresponding data of the coordinates of an intersection point of the first row generating errors and the first column generating errors and the corresponding data of the coordinates of an intersection point of the second row generating errors and the second column generating errors if the number of the column generating errors is 2 and the number of the row generating errors is 2, computing Hash value of the data in the data area, returning right and keeping the inverted data of data in the coordinates of the intersection point of the first row generating errors and the first column generating errors and the corresponding data of the coordinates of the intersection point of the second row generating errors and the second column generating errors; returning wrong if the computed Hash value is different from the new Hash value;
inverting the corresponding data of the coordinates of an intersection point of the first row generating errors and the second column generating errors and the corresponding data of the coordinates of an intersection point of the second row generating errors and the first column generating errors if the number of the column generating errors is 2 and the number of the row generating errors is 2, computing Hash value of the data in the data area, returning right and keeping the inverted data of data in the coordinates of the intersection point of the first row generating errors and the first column generating errors and the corresponding data of the coordinates of the intersection point of the second row generating errors and the second column generating errors; returning wrong if the computed Hash value is different from the new Hash value.
